(19) United States
(12) Patent Application Publication
(10) Pub. No.: US 2012/0256981 A1
(43) Pub. Date: Oct. 11, 2012

(54) LIQUID EJECTING APPARATUS AND CONTROL METHOD THEREOF

(75) Inventor: Hiroyuki MATSUO, Shiojiri (JP)

(73) Assignee: SEIKO EPSON CORPORATION, Tokyo (JP)

(21) Appl. No.: 13/438,481

(22) Filed: Apr. 3, 2012

(30) Foreign Application Priority Data
Apr. 6, 2011 (JP) 2011-084250

(51) Int. Cl. B41J 29/38

(52) U.S. Cl. 347/14

(57) ABSTRACT

A recording head ejects colored ink and clear ink from a plurality of nozzles to the recording paper. A control device controls a recording head to eject the colored ink to the recording paper in accordance with control data designating an image to be formed and controls the recording head to eject the clear ink so as to form a dust suppressing pattern on the recording paper, that is arranged by repeating a unit pattern including an ejecting region to which the clear ink is ejected and a thinning region to which the clear ink is not ejected.

Priority is claimed on Japanese Patent Application No. 2011-084250, filed Apr. 6, 2011, the content of which is incorporated herein by reference.

### TECHNICAL FIELD

The present invention relates to a technique of ejecting liquid such as ink.

### BACKGROUND ART

In the related art, a liquid ejecting apparatus has been proposed which drives a pressure generating element such as a piezoelectric element and a heater element to eject liquid in a pressure chamber from a nozzle. For example, in Patent Literature 1, a configuration of ejecting transparent clear ink having no color in addition to colored ink containing a coloring agent such as a pigment or dye is disclosed.

### CITATION LIST

### Patent Literature

[PTL 1] JP-A-8-95218

### SUMMARY OF INVENTION

### Technical Problem

However, in a case of ejecting liquid to recording paper such as copy paper as a landing target, it is possible that dust (for example, paper dust separated from fibers of the recording paper) attached to the recording paper scatters. Further, if dust scattered from the recording paper becomes attached to the vicinity or inside each of the nozzles, there are problems in that the ejecting characteristics (ejecting amount, ejecting speed and ejecting direction) of the liquid fluctuates, or missing dots (a state where the liquid is not ejected from the nozzles due to clogging by the dust) occur. Considering above problems, an object of the invention is to suppress a scattering of the dust from a landing target.

### Solution to Problem

To solve the above problems, a liquid ejecting apparatus of the invention includes: a liquid ejecting unit that includes a first nozzle ejecting a colored droplet of a first liquid to a landing target and a second nozzle ejecting a almost imperceptible droplet of a second liquid to the landing target; and control means for controlling the liquid ejecting unit to eject the first liquid to the landing target according to control data which designates an image to be formed, and for controlling the liquid ejecting unit to eject the second liquid so as to form a first dust suppressing pattern on the landing target that is arranged by repeating a unit pattern including an ejecting region to which the second liquid is ejected and a thinning region to which the second liquid is not ejected.

In the above configuration, it is possible that scattering of dust (paper dust) from the landing target is suppressed by a first dust suppressing pattern formed by the almost imperceptible second liquid. In addition, since the first dust suppressing pattern includes a plurality of unit patterns including an ejecting region to which the second liquid is ejected and a thinning region to which the second liquid is not ejected (that is, the ejection of the second liquid is performed in thinned-out manner), it is possible that the consumed amount of the second liquid is reduced compared to the configuration of ejecting the second liquid over the entire surface of the landing target. Further, when recording paper is set as the landing target for example, it is advantageous to suppress the generation of wrinkles of the recording paper due to excessive permeation of the second liquid.

The colored liquid means liquid having a color which is visible by an observer, and is for example, liquid containing a colored agent such as a dye or a pigment. On the other hand, almost imperceptible liquid means liquid that is almost imperceptible by an observer, and is for example, transparent liquid (for example, clear ink) having no color, or liquid (for example, white ink) having the same color as the surface of the landing target.

In the preferred embodiment of the invention, a center-to-center distance between two ejecting regions adjacent to each other may be smaller than the total value of a diameter of a dot which is formed by the second liquid landed on the landing target and a diameter of the nozzle. In the above embodiment, since the space of the dots formed by the second liquid is smaller than the diameter of the nozzle, it is advantageous that each of dots is formed so as to cover at least a part of the dust of which an external dimension is larger than the diameter of the nozzle and the scattering of the dust is effectively suppressed.

In a preferred embodiment of the invention, the liquid ejecting unit may eject any of a plurality of kinds of droplets, which have a different weight to each other, from the nozzle, and the control means may control the liquid ejecting unit to eject the lightest droplet from the plural kinds of droplets as the second liquid. In the above embodiment, since the second liquid is ejected as the lightest droplet, an effect of reducing the consumed amount of the second liquid is significantly and highly achieved.

In a preferred embodiment of the invention, the control means may control the liquid ejecting unit to eject the second liquid so as to form the first dust suppressing pattern on a first region of the landing target and to form a second dust suppressing pattern on the second region that is different from the first region, and the number of times of ejection (dot density) of the second liquid to a unit area of the second region may be higher than the number of times of ejection of the second liquid to a unit area of the first region. In the above embodiment, since the second dust suppressing pattern which has a higher dot density than that of the first dust suppressing pattern is formed on the second region, it is possible that the scattering of the dust from the second region is effectively suppressed. In addition, it is advantageous that the consumed amount of the second liquid is reduced compared to the configuration in which the second dust suppressing pattern is formed on both the first region and the second region. Further, when recording paper is set as the landing target for example, the dust significantly attaches particularly to the periphery of the recording paper (transverse section). Accordingly, a configuration of forming the second dust suppressing pattern by setting a region along the periphery of the landing target as the second region is highly suitable.

The invention also suggests a method of controlling the liquid ejecting apparatus related to each embodiment described above. A control method of a liquid ejecting apparatus according to the invention which includes a liquid ejecting unit ejecting a colored first liquid and almost imperceptible second liquid to a landing target from a plurality of nozzles, the method includes: controlling the liquid ejecting unit to eject the first liquid to the landing target according to control data which designates an image to be formed; and controlling the liquid ejecting unit to eject the second liquid so as to form a first dust suppressing pattern on the landing target that is arranged by repeating a unit pattern including an ejecting region to which the second liquid is ejected and a thinning region to which the second liquid is not ejected. In the above control method, the same action and effect are realized as the liquid ejecting apparatus of the invention.

### BRIEF DESCRIPTION OF DRAWINGS

FIG. 1 is a partial configuration view of a printing apparatus according to a first embodiment of the invention.

FIG. 2 is a plan view of a discharge surface of a recording head.

FIG. 3 is a partial block diagram of a printing apparatus.

FIG. 4 is an explanatory view of a dust suppressing pattern.

FIG. 5 is a schematic view showing a positional relationship of ejecting regions in a dust suppressing pattern.

FIG. 6 is an explanatory view of a dust suppressing pattern in a second embodiment.

### DESCRIPTION OF EMBODIMENTS

### A: FIRST EMBODIMENT

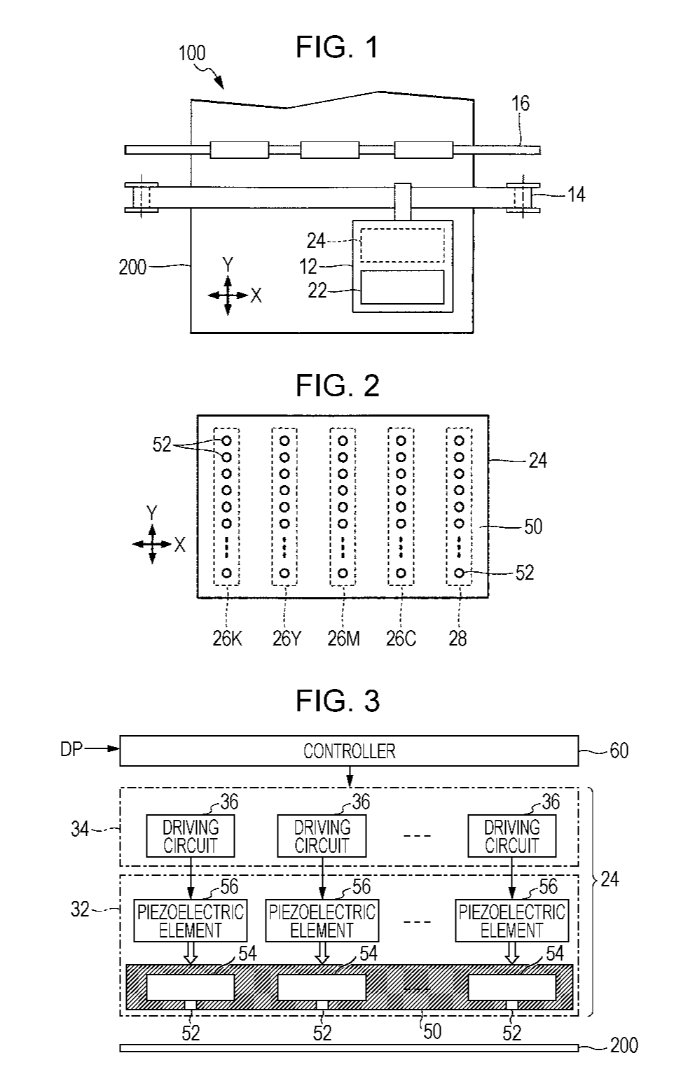

FIG. 1 is a partial schematic view of an ink jet type printing apparatus 100 according to a first embodiment of the invention. The printing apparatus 100 is a liquid ejecting apparatus which ejects droplets of ink to the recording paper 200, and includes a carriage 12, movement mechanism 14, and paper transporting mechanism 16. The recording paper 200 is paper (so-called copy paper or plain paper) to which micro dust (powder) separated from the fiber configuring the paper can become attached.

An ink cartridge 22 and a recording head 24 are mounted on the carriage 12. The ink cartridge 22 is a container for retaining ink to eject to the recording paper 200. Plural kinds of colored ink (black(K), yellow(Y), magenta(M), and cyan(C)) including a coloring agent such as a pigment or a dye, and almost imperceptible clear ink having no color that does not include a coloring agent are retained in the ink cartridge 22. The recording head 24 functions as a liquid ejecting unit to eject the ink supplied from the ink cartridge 22 to the recording paper 200. In addition, an off-carriage method can be also employed in that the ink cartridge 22 is fixed to a case (not shown) of the printing apparatus 100 and the ink is supplied to the recording head 24.

The movement mechanism 14 controls the carriage 12 to reciprocate in the X direction (main scanning direction). The paper transporting mechanism 16 transports the recording paper 200 in the Y direction (vertical scanning direction) in parallel with the reciprocation of the carriage 12. The recording head 24 ejects the ink to the recording paper 200 when the carriage 12 reciprocates, and thus a desired image is recorded on the recording paper 200.

FIG. 2 is a plan view of a discharge surface 50 of the recording head 24 facing the recording paper 200. As shown in FIG. 2, the discharge surface 50 of the recording head 24 is provided with a plurality of nozzle arrays 26 (26K, 26Y, 26M, and 26C) corresponding to the colored ink and a nozzle array 28 corresponding to the clear ink. Each of the nozzle array 26 and the nozzle array 28 is an assembly of a plurality of nozzles (discharge port) 52 which are arranged linearly in the Y direction (vertical scanning direction). In addition, the plurality of nozzles 52 can also be arranged in zigzags.

The black ink droplet is ejected from each of the nozzles 52 of the nozzle array 26K. Similarly, the yellow ink is ejected from each of the nozzles 52 of the nozzle array 26Y, the magenta ink is ejected from each of nozzles 52 of the nozzle array 26M, and the cyan ink is ejected from each of nozzles 52 of the nozzle array 26C. In addition, the clear ink is ejected from each of nozzles 52 of the nozzle array 28. Further, the head for ejecting the colored ink and the head for ejecting the clear ink can be divided into separate heads.

FIG. 3 is a partial block diagram of a printing apparatus 100. As shown in FIG. 3, the printing apparatus 100 includes a control device 60 and the recording head 24 described above. The control device 60 is an arithmetic processing unit for executing a control program recorded in the memory circuit (not shown) for example, and integrally controls each part (for example, the recording head 24, the movement mechanism 14, and the paper transporting mechanism 16) of the printing apparatus 100. Control data (image data) DP designating an image to be formed on the recording paper 200 is supplied from an external apparatus (not shown) such as a host computer to the control device 60.

As shown in FIG. 3, the recording head 24 includes an ejecting unit 32 and a drive unit 34. The ejecting unit 32 includes a plurality of pressure chambers 54 that are filled by ink supplied from the ink cartridge 22 and a plurality of piezoelectric elements 56 corresponding to each of pressure chambers 54. The nozzles 52 (through holes) are formed on walls of the pressure chambers 54 facing the recording paper 200.

The drive unit 34 includes a plurality of drive circuits 36 corresponding to each piezoelectric element 56. Each of the drive circuits 36 drives the piezoelectric elements 56 for each predetermined period (hereinafter, referred to as a “printing period”) with the supply of a drive signal in accordance with an instruction from the control device 60. The piezoelectric element 56 is a pressure oscillator that oscillates in accordance with the drive signal supplied from the drive circuit 36. The piezoelectric element 56 changes the pressure of the ink inside the pressure chamber 54, and thus the ink inside the pressure chamber 54 is ejected from the nozzle 52 for each printing period and is landed on the recording paper 200. The drive circuit 36 can selectively eject any one of a large ink droplet and a small ink droplet that have different weights from each of the nozzles 52 with the driving of the piezoelectric element 56.

The control device 60 controls the recording head 24 such that the colored ink is ejected in accordance with the control data DP from the nozzle 52 of the each nozzle array 26 (26K, 26Y, 26M and 26C). Specifically, the control device 60 determines the necessity or ejection amount (large ink droplet/small ink droplet) of the ink from each nozzle 52 in accordance with the control data DP and instructs each drive circuit 36 so as to form the image specified by the drive data DP on the recording paper 200 by the colored ink.

In addition, the control device 60 controls the recording head 24 so as to form a predetermined pattern (hereinafter, referred to as a “dust suppressing pattern”) P for suppressing the scattering of the dust from the recording paper 200 on the recording paper 200 by the clear ink, in parallel with the formation of the image by the colored ink. Specifically, the dust suppressing pattern P is formed by ejecting small ink droplet of the clear ink (that is, the lightest droplet of a plurality of kinds of droplets) from each nozzle 52 of the nozzle array 28. The dust suppressing pattern (first dust suppressing pattern) P is selected in advance irrespective of the control data DP as will be described below.

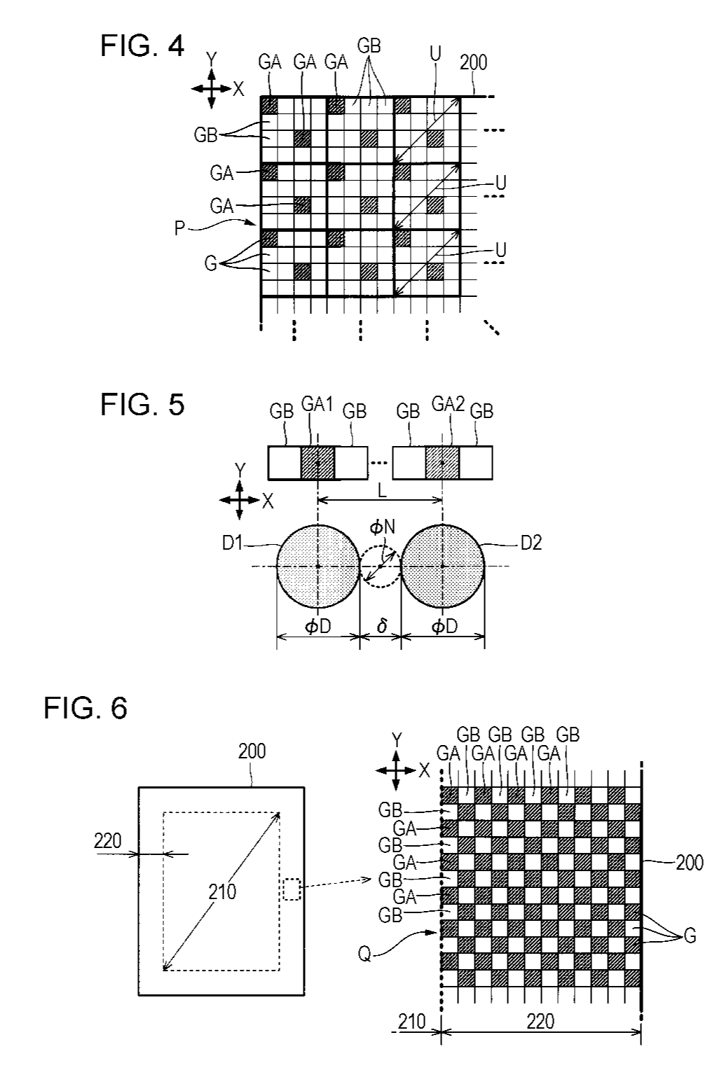

FIG. 4 is an explanatory view of a dust suppressing pattern P formed on the recording paper 200. As shown in FIG. 4, a plurality of pixel regions G (GA, GB) arranged in a matrix in the X direction and Y direction are defined on the surface of the recording paper 200. Each of the pixel regions G is a region that is to be a target of the landing of the ink ejected from one nozzle in one printing period. In practice, each of the pixel regions G adjacent in the X direction or Y direction may be overlapped with each other.

As shown in FIG. 4, the dust suppressing pattern P is configured of a plurality of unit patterns U repeated in the X direction and Y direction. Each of unit patterns U includes a plurality of pixel regions G arranged in a matrix in the X direction and Y direction. A plurality of pixel regions G corresponding to one unit pattern U are divided into a pixel region G (hereinafter, referred to as an “ejecting region GA”) on which the clear ink ejected from the recording head 24 is landed, and a pixel region G (hereinafter, referred to as a “thinning region GB”) on which the clear ink is not ejected. That is, the dust suppressing pattern P is formed by not ejecting the clear ink over the entire pixel regions G but ejecting by thinning out the predetermined rate (for example, every three of the pixel regions G). Each of ejection region GA and thinning region GB in the unit pattern U is common in arrangement (position or number) with respect to the plurality of unit patterns U.

As described above, in the first embodiment, the dust suppressing pattern P is formed by the ejecting the clear ink to the recording paper 200. Since the droplet of the clear ink landed on the ejecting region GA is dried in a state where a part or the entire dust attached to the surface of the recording paper 200 is covered, the scattering of the dust from the recording paper 200 can be prevented. Accordingly, the attachment of the dust to the vicinity or the inside of each nozzle 52 is prevented, and it is advantageous that the missing dots or fluctuations in ejecting characteristics (ejecting amount, ejecting speed and ejecting direction) of the ink caused by the attachment of the dust are suppressed. In addition, since the scattering of the dust is suppressed, it is possible that the cleaning process frequency is lowered which eliminates the dust from the nozzles 42 (and power consumption is reduced). In addition, since the dust suppressing pattern P is formed by the transparent clear ink having no color, the visibility of the image formed on the recording paper 200 by the colored ink is not affected.

Further, considering only the point of preventing the scattering of the dust on the recording paper 200, the configuration can be supposed that the clear ink is ejected over the entire pixel regions G of the recording paper 200 (coloring all one color). However, when ejecting the clear ink over the entire pixel regions G, there are problems in that the amount of clear ink consumed is increased and wrinkles are generated on the recording paper 200 due to the excessive permeation of the clear ink. In the first embodiment, the dust suppressing pattern P is formed in which the ejecting region GA on which the clear ink is landed and the thinning region GB on which the clear ink is not landed are arranged (that is, the ejection of the clear ink is thinned out). However, as compared to the case of ejecting the clear ink over the entire pixel regions G, it is advantageous that the amount of clear ink consumed is reduced and the generation of wrinkles on the recording paper 200 is suppressed. In addition, since the clear ink is ejected as small ink droplets in the first embodiment, a highly significant effect is achieved that the amount of clear ink consumed is reduced, compared to the case where the clear ink is ejected as large ink droplets and the dust suppressing pattern P is formed.

Meanwhile, various sizes of dust may be attached to the recording paper 200, however, the dust having the diameter equivalent to or larger than the diameter (inner diameter) φN of each nozzle 52 of the recording head 24 tends to generate particularly the fluctuations in the ejecting characteristics of the ink or the missing dots when attached to the vicinity or the inside of the nozzle 52. Here, the appearance (position or numbers) of each ejecting region GA in the dust suppressing pattern P is selected so as that particularly the dust of which the external dimensions (diameter) is equal to or larger than the diameter φN of the nozzle 52 of the dust that can be scattered from the recording paper 200, is effectively held on the surface of the recording paper 200 by the clear ink of each ejecting region GA.

FIG. 5 shows two ejecting regions GA (GA1, GA2) which are adjacent to each other in the X direction with some thinning regions GB interposed therebetween of the dust suppressing pattern P, and dots D (D1, D2) which are formed on the recording paper 200 by the clear ink ejected on each ejecting region GA. A center-to-center distance L between the ejecting region GA1 and the ejecting region GA2 of the dust suppressing pattern P is set so as that the space δ between the dot D1 formed on the ejecting region GA1 and the dot D2 formed on the ejecting region GA2 is smaller than the diameter φN (that is, particularly the smallest diameter of the dust which is particularly a problem) of the nozzle 52.

If the diameter of each of the dots D (D1, D2) formed by the clear ink is set to φD, as understood from FIG. 5, the center-to-center distance L between the ejecting region GA1 and the ejecting region GA2 is set so as to be smaller than the sum of the diameter φD of the dot D and the diameter φN of the nozzle 52 (L<φD+φN). Further, the attention is paid on the two ejecting regions GA (GA1, GA2) in the above description; however, in the dust suppressing pattern P, the above relationship is satisfied for an arbitrary combination of two ejecting regions GA adjacent to each other in the X direction. In addition, the relationship the same as the above relationship (L<φD+φN) is satisfied for an arbitrary combination of two ejecting regions GA adjacent to each other in the Y direction in the dust suppressing pattern P.

As described above, in the first embodiment, since the center-to-center distance L between each of the ejecting regions GA is set so as that the space δ of each dot D formed by the clear ink is smaller than the diameter φN of the nozzle 52, at least a part of the dust having a diameter equal to or larger than the diameter φN positioned on the space between each of the dots D is inevitably covered by the dots D and held on the surface of the recording paper 200. Accordingly, in a case of being attached to the nozzle 52, it is advantageous that the scattering of the dust having the diameter equal to or larger than the diameter φN is effectively suppressed that tends to particularly generate the missing dots or the fluctuations of the ejecting characteristics of the ink.

### B: SECOND EMBODIMENT

A second embodiment of the invention will be described below. Further, the components having an action or a function in each embodiment exemplified below which are the same as the first embodiment will be referred to the reference numerals referred to the above descriptions and the detailed descriptions thereof will be omitted.

FIG. 6 is a plan view of the recording paper 200. As shown in FIG. 6, the surface of the recording paper 200 is divided into a first region 210 and a second region 220. The second region 220 is a region having a rectangular frame shape along the periphery of the recording paper 200 so as to surround the first region 210. The dust tends to be attached to the peripheral region of the recording paper 200 (a vicinity in the region of a transverse section in the production process of the recording paper 200), that is to the second region 220 of the recording paper 200.

The dust suppressing pattern P having the same configuration as the example of the FIG. 4 is formed by the clear ink on the first region 210. On the other hand, as expanded and shown in FIG. 6, a dust suppressing pattern (second dust suppressing pattern) Q which is different from the dust suppressing pattern P is formed by the clear ink on the second region 220. The dust suppressing pattern Q is an array of an ejecting region GA on which the clear ink is ejected and a thinning region GB on which the clear ink is not ejected. As understood from the comparison between FIG. 4 and FIG. 6, the proportion of the ejecting region GA in the dust suppressing pattern Q is higher than the proportion of the ejecting region GA in the dust suppressing pattern P. That is, the number of times of ejection (dot density) of the clear ink to a unit area of the second region 220 is greater than the number of times of the ejection of the clear ink to a unit area of the first region 210.

As described above, in the second embodiment, since the dust suppressing pattern Q having a dot density higher than that of the dust suppressing pattern P is formed on the second region 220, it is advantageous that the scattering of the dust which is particularly easily attached to the second region 220, is effectively suppressed. Further, when the high-density dust suppressing pattern Q is formed over the entire recording paper 200 (both on the first region 210 and on the second region 220), it is problem that the amount of clear ink consumed is increased. In the second embodiment, in the first region 210, since the dust suppressing pattern P is formed which having the dot density lower than that of the dust suppressing pattern Q, it is possible that the amount of clear ink consumed is decreased compared to a case where the dust suppressing pattern Q is formed over the entire recording paper 200. That is, according to the second embodiment, it is possible to achieve both the effect of suppressing the scattering of the dust on the recording paper 200 effectively and the effect of reducing the amount of clear ink consumed.

### C: MODIFICATION EXAMPLES

Each embodiment described above may be modified in various ways. Specific modified embodiments are described below. Two or more embodiments selected arbitrarily from the examples below can be suitably combined.

(1) In the first embodiment, the dust suppressing pattern P is formed over the entire surface of the recording paper 200; however, it is possible that the dust suppressing pattern P is formed only on a part of region (hereinafter, referred to as a “dust suppressing region”) of the recording paper 200. Similarly, in the second embodiment, it is possible that the dust suppressing pattern P is formed on the first region 210 in the dust suppressing region, and the dust suppressing pattern Q is formed on the second region 220 in the dust suppressing region. In any embodiment, the clear ink is not ejected to the region other than the dust suppressing region. In addition, the dust suppressing region, for example, can be set in advance as the region on which the dust is easily attached. Further, it is possible that the detector (for example, an imaging apparatus) detecting the dust on the recording paper 200 is provided, and the control device 60 selects the region of the recording paper 200 on which the dust is detected as the dust suppressing region, and then the dust suppressing pattern or the dust suppressing pattern Q is formed.

(2) The ejection of the clear ink can be suppressed in accordance with the degree of the attachment of the dust of the recording paper 200. For example, a configuration of increasing the ejecting amount (diameter φD of the dot D) of the clear ink as the dust of the recording paper 200 increases, or a configuration of increasing the dot density (number of times of ejecting per unit area) of the clear ink as the dust of the recording paper 200 increases, can be employed. A method of detecting the dust is arbitrary; however, for example, it is possible that the imaged result of the surface of the recording paper 200 by the imaging apparatus is analyzed by the control device 60 and the degree of attachment of the dust is specified.

(3) In the second embodiment, a frame-shaped region along the periphery of the recording paper 200 is set as the second region 220; however, the second region 220 can be selected arbitrarily. For example, a linear region along the margin of the recording paper 200 in the X direction or Y direction can be set as the second region 220 and the dust suppressing pattern Q can be formed.

(4) The order of ejection of the colored ink and the ejection of the clear ink is optional. That is, a configuration of forming the dust suppressing pattern P or the dust suppressing pattern Q by the clear ink after forming an image by the colored ink, or a configuration of forming an image by the colored ink after forming the dust suppressing pattern P and the dust suppressing pattern Q can be employed.

(5) The ink which is applied when forming the dust suppressing pattern P and the dust suppressing pattern Q is not limited to the clear ink. For example, when an image is formed on white recording paper 200, the dust suppressing pattern P or the dust suppressing pattern Q can be formed by white ink. Meanwhile, in a case of using the white ink, it is necessary to form the dust suppressing pattern P or the dust suppressing pattern Q before the formation of the image by the colored ink. As understood from the above examples, the ink used for the forming of the dust suppressing pattern P and the dust suppressing pattern Q includes almost imperceptible ink which is almost imperceptible by the observer after forming an image on the recording paper 200, and the clear ink or the ink having same color as the recording paper 200 is an example of the almost imperceptible ink. On the other hand, the colored ink which is applied when forming the image in accordance with the control data DP is defined as a kind of ink that is visible by the observer, and is typically ink including a coloring agent such as a dye or a pigment.

(6) In the second embodiment, the dust suppressing pattern Q is described in which the ejecting region GA on which the clear ink is ejected and the thinning region GB on which the clear ink is not ejected are arranged, however, since the clear ink is ejected over the entire pixel regions G in the second region 220, a configuration of forming the dust suppressing pattern Q (that is, a configuration in which the dust suppressing pattern Q does not include the thinning region GB) is employed.

(7) In the above embodiments, the serial type printing apparatus 100 is described which causes the carriage 12 on which the recording head 24 is mounted to move, however, the embodiments of the present invention can be applied to the line type printing apparatus 100 in which the plurality of the nozzles 52 are arranged so as to face the entire region of the recording paper 200 in a width direction. The recording head 24 is fixed to the line type printing apparatus 100 and an image is recorded on the recording paper 200 by ejecting ink droplet from each nozzle 52 while transporting the recording paper 200. As understood from the above description, the recording head 24, itself, can be in a movable state or in a fixed state in the invention.

(8) The configuration of the element (pressure generating element) that changes the pressure of the ink in the pressure chamber 54 is not limited to the above description. For example, a vibrator such as a static actuator can be used. Further, the pressure generating element of the invention is not limited to the element which imparts a mechanical vibration to the pressure chamber 54. For example, a heater element (heater) that generates air bubble by heating the pressure chamber 54 and changes the pressure of the ink in the pressure chamber 54 can be used as the pressure generating element. That is, the pressure generating element of the invention includes elements that change the pressure of the ink in the pressure chamber 54, and the method (piezo method/thermal method) or the configuration of changing the pressure is not limited.

(9) The printing apparatus 100 in the above described embodiments can be employed to various image forming apparatus such as a plotter, facsimile machine or a copy machine.

### REFERENCE SIGN LIST

100: PRINTING APPARATUS

12: CARRIAGE

14: MOVING MECHANISM

16: PAPER TRANSPORTING MECHANISM

22: INK CARTRIDGE

24: RECORDING HEAD

26 (26K, 26Y, 26M, 26C), 26: NOZZLE ARRAY

32: EJECTING UNIT

34: DRIVE UNIT

36: DRIVE CIRCUIT

50: DISCHARGE SURFACE

52: NOZZLE

54: PRESSURE CHAMBER

56: PIEZOELECTRIC ELEMENT

60: CONTROL DEVICE

200: RECORDING PAPER

G: PIXEL REGION

GA: EJECTING REGION

GB: THINNING REGION

210: FIRST REGION

220: SECOND REGION

1. A liquid ejecting apparatus comprising:
a liquid ejecting unit that includes a first nozzle ejecting a colored droplet of a first liquid to a landing target and a second nozzle ejecting a almost imperceptible droplet of a second liquid to the landing target; and
control means for controlling the liquid ejecting unit to eject the first liquid to the landing target according to control data which designates an image to be formed, and for controlling the liquid ejecting unit to eject the second liquid so as to form a first dust suppressing pattern on the landing target that is arranged by repeating a unit pattern including an ejecting region to which the second liquid is ejected and a thinning region to which the second liquid is not ejected.

2. The liquid ejecting apparatus according to claim 1,
wherein a center-to-center distance between two ejecting regions adjacent to each other is smaller than the total value of a diameter of a dot which is formed by the second liquid landed on the landing target and a diameter of the nozzle.

3. The liquid ejecting apparatus according to claim 1,
wherein the liquid ejecting unit ejects any of a plurality of kinds of droplets which have different weights to each other from the nozzle, and
the control means controls the liquid ejecting unit to eject the second liquid as the lightest droplet from the plurality of kinds of droplets.

4. The liquid ejecting apparatus according to claim 2,
wherein the liquid ejecting unit ejects any of plurality of kinds of droplets which have different weights to each other from the nozzle, and
the control means controls the liquid ejecting unit to eject the second liquid as the lightest droplet from the plurality of kinds of droplets.

5. The liquid ejecting apparatus according to claim 1,
wherein the control means controls the liquid ejecting unit to eject the second liquid so as to form the first dust suppressing pattern on a first region of the landing target and to form a second dust suppressing pattern on a second region that is different from the first region, and
the number of times of ejection of the second liquid to a unit area of the second region is higher than the number of times of ejection of the second liquid to a unit area of the first region.

6. The liquid ejecting apparatus according to claim 2,
wherein the control means controls the liquid ejecting unit to eject the second liquid so as to form the first dust suppressing pattern on a first region of the landing target and to form a second dust suppressing pattern on a second region that is different from the first region, and
the number of times of ejection of the second liquid to a unit area of the second region is higher than the number of times of ejection of the second liquid to a unit area of the first region.

7. The liquid ejecting apparatus according to claim 3,
wherein the control means controls the liquid ejecting unit to eject the second liquid so as to form the first dust suppressing pattern on a first region of the landing target and to form a second dust suppressing pattern on a second region that is different from the first region, and
the number of times of ejection of the second liquid to a unit area of the second region is higher than the number of times of ejection of the second liquid to a unit area of the first region.

8. The liquid ejecting apparatus according to claim 5,
wherein the second region is a region along a periphery of the landing target.

9. The liquid ejecting apparatus according to claim 6,
wherein the second region is a region along a periphery of the landing target.

10. The liquid ejecting apparatus according to claim 7,
wherein the second region is a region along a periphery of the landing target.

11. A control method of a liquid ejecting apparatus which includes a liquid ejecting unit ejecting a colored first liquid and a almost imperceptible second liquid to a landing target from a plurality of nozzles, the method comprising:
controlling the liquid ejecting unit to eject the first liquid to the landing target according to control data which designates an image to be formed; and
controlling the liquid ejecting unit to eject the second liquid so as to form a first dust suppressing pattern on the landing target that is arranged by repeating a unit pattern including an ejecting region to which the second liquid is ejected and a thinning region to which the second liquid is not ejected.
